(19) United States
(12) Patent Application Publication
(10) Pub. No.: US 2025/0363771 A1
(43) Pub. Date: Nov. 27, 2025

(54) METHOD AND SYSTEM FOR MULTI-MODAL BASED DOCUMENT ANALYSIS

(71) Applicants: SAMSUNG SDS CO., LTD., Seoul (KR); SEOUL NATIONAL UNIVERSITY R&DB FOUNDATION, Seoul (KR)

(72) Inventors: Jeong Hyung PARK, Seoul (KR); Bohyung HAN, Seoul (KR); Jae Yoo PARK, Seoul (KR)

(73) Assignees: SAMSUNG SDS CO., LTD., Seoul (KR); SEOUL NATIONAL UNIVERSITY R&DB FOUNDATION, Seoul (KR)

(21) Appl. No.: 19/213,492

(22) Filed: May 20, 2025

(30) Foreign Application Priority Data
May 21, 2024 (KR) 10-2024-0065711
Oct. 14, 2024 (KR) 10-2024-0139435

(51) Int. Cl. G06V 10/44; G06T 3/40; G06T 7/11; G06V 10/80

(52) U.S. Cl. CPC G06V 10/44; G06T 3/40; G06T 7/11; G06V 10/806

(57) ABSTRACT

A multimodal-based document analysis method is provided, the method comprising generating multi-scale sub-images from a document image, extracting representative visual features corresponding to the respective sub-images, and generating a response for a target task based on the representative visual features using a language model.

### CROSS-REFERENCE TO RELATED APPLICATIONS

This application claims priority from Korean Patent Application No. 10-2024-0065711 filed on May 21, 2024, and Korean Patent Application No. 10-2024-0139435 filed on Oct. 14, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for multimodal-based document analysis, and more particularly, to a method and system for effectively enhancing the performance of multimodal-based document image analysis.

### 2. Description of the Related Art

Recently, interest in multimodal analysis, which performs complex analysis using both text and images, has significantly increased. Accordingly, research has been continuously conducted on document analysis models based on multimodal large language models and training methods for such models.

To improve the performance of multimodal-based large language models, known methods include training on low-resolution document images using a large volume of training data, and also involve receiving optical character recognition (OCR) information for the text within the document images to improve text recognition capability. However, such methods present the following problems.

First, when training is performed using low-resolution document images, information in high-resolution document images may be lost. For example, text in a small font size within a high-resolution image may become distorted during resizing, which can reduce the accuracy of document image analysis. Furthermore, when OCR information is extracted from the text in each document image using an OCR engine, and the analysis is based on that information, the recognition accuracy of the OCR engine may be limited for text in various font sizes, handwritten text, and aged or faded documents.

To address this, attempts have been made to perform document image analysis without OCR, that is, in an OCR-free manner, by dividing a high-resolution document image to extract a plurality of sub-images and performing analysis using them. However, some regions of the document image may be lost during the division process, and the computing cost required to process multiple high-resolution images significantly increases.

### SUMMARY

One objective of the present disclosure is to provide a method for improving the performance of document image analysis and a system for performing the method.

Another objective of the present disclosure is to provide a method for enhancing the performance of multimodal tasks based on document images and a system for performing the method.

The objectives of the present disclosure are not limited to those mentioned above, and other objectives not explicitly stated will be clearly understood by those skilled in the art based on the following description.

According to an aspect of the present disclosure, there is provided a multimodal-based document analysis method, performed by at least one computing device. The method may comprise generating multi-scale sub-images using a document image, the multi-scale sub-images including first sub-images of a first scale and second sub-images of a second scale different from the first scale, extracting representative visual features corresponding to the respective first sub-images by using second sub-images corresponding to each of the first sub-images, and generating a response for a target task based on the representative visual features using a language model.

In some embodiments, the generating of the multi-scale sub-images may comprise generating the first sub-images of the first scale having an aspect ratio corresponding to that of the document image by dividing the document image, and resizing the first sub-images to a resolution corresponding to the document image.

In some embodiments, the generating of the multi-scale sub-images may comprise generating the second sub-images of the second scale by dividing a corresponding first sub-image, and resizing the second sub-images to a resolution corresponding to the document image.

In some embodiments, the generating of the representative visual features may comprise extracting compressed visual features by using visual features of the second sub-images corresponding to each of the first sub-images, the compressed visual features having a size corresponding to that of the visual features of the first sub-images, and generating the representative visual features corresponding to the respective first sub-images by fusing the visual features of the first sub-images with the corresponding compressed visual features.

In some embodiments, the extracting of the compressed visual features may comprise extracting pooled visual features by applying max pooling to the visual features of the second sub-images corresponding to each of the first sub-images, and generating the compressed visual features by applying cross attention between the pooled visual features and the visual features of the second sub-images.

In some embodiments, the generating of the compressed visual features may comprise performing a cross attention operation in which the pooled visual features are used as query inputs and the visual features of the second sub-images are used as key and value inputs.

According to another aspect of the present disclosure, there is provided a multimodal-based document analysis method, performed by at least one computing device. The method may comprise generating multi-scale sub-images using a document image sample, the multi-scale sub-images including first sub-images of a first scale and second sub-images of a second scale different from the first scale, extracting representative visual features corresponding to the respective first sub-images by using second sub-images corresponding to each of the first sub-images through a visual feature integration model, and updating the visual feature integration model and a language model by performing a target task based on the representative visual features using the language model.

In some embodiments, the generating of the multi-scale sub-images may comprise generating the first sub-images of the first scale having an aspect ratio corresponding to that of the document image sample by dividing the document image sample, and resizing the first sub-images to a resolution corresponding to the document image sample.

In some embodiments, the generating of the multi-scale sub-images may comprise generating the second sub-images of the second scale by dividing a corresponding first sub-image, and resizing the second sub-images to a resolution corresponding to the document image sample.

In some embodiments, the generating of the representative visual features may comprise extracting compressed visual features by using visual features of second sub-images corresponding to each of the first sub-images, the compressed visual features having a size corresponding to that of the visual features of the first sub-images, and generating the representative visual features corresponding to the respective first sub-images by fusing the visual features of the first sub-images with the corresponding compressed visual features.

In some embodiments, the extracting of the compressed visual features may comprise extracting pooled visual features by applying max pooling to the visual features of the second sub-images corresponding to each of the first sub-images, and generating the compressed visual features by applying cross attention between the pooled visual features and the visual features of the second sub-images.

In some embodiments, the updating of the visual feature integration model and the language model may comprise generating reconstructed visual features by reconstructing the compressed visual features, calculating visual feature compression loss based on similarity between the reconstructed visual features and the visual features of the second sub-images, and updating the visual feature integration model based on the visual feature compression loss.

In some embodiments, the target task may include a task associated with relative position information of text in the document image sample.

According to another aspect of the present disclosure, there is provided a multimodal-based document analysis system comprising at least one processor, and a memory storing a computer program executed by the at least one processor, wherein the computer program may include instructions for, generating multi-scale sub-images using a document image, the multi-scale sub-images including first sub-images of a first scale and second sub-images of a second scale different from the first scale, extracting representative visual features corresponding to the respective first sub-images by using second sub-images corresponding to each of the first sub-images, and generating a response for a target task based on the representative visual features using a language model.

In some embodiments, the generating of the multi-scale sub-images may comprise generating the first sub-images of the first scale having an aspect ratio corresponding to that of the document image by dividing the document image, and resizing the first sub-images to a resolution corresponding to the document image.

In some embodiments, the generating of the multi-scale sub-images may comprise generating the second sub-images of the second scale by dividing a corresponding first sub-image, and resizing the second sub-images to a resolution corresponding to the document image.

In some embodiments, the generating of the representative visual features may comprise extracting compressed visual features by using visual features of second sub-images corresponding to each of the first sub-images, the compressed visual features having a size corresponding to that of the visual features of the first sub-images, and generating the representative visual features corresponding to the respective first sub-images by fusing the visual features of the first sub-images with the corresponding compressed visual features.

In some embodiments, the extracting of the compressed visual features may comprise extracting pooled visual features by applying max pooling to visual features of the second sub-images corresponding to each of the first sub-images, and generating the compressed visual features by applying cross attention between the pooled visual features and the visual features of the second sub-images.

In some embodiments, the generating of the compressed visual features may comprise performing a cross attention operation in which the pooled visual features are used as query inputs, and the visual features of the second sub-images are used as key and value inputs.

According to some embodiments of the present disclosure, multi-scale sub-images of a high-resolution document image are generated, and representative visual features with minimal information loss are extracted, such that the computing and time costs required to process the visual features can be significantly reduced, enabling analysis that considers detailed information of the document image.

In addition, by performing training using a task associated with the relative positional information of text within the document image, the text recognition capability for the document image can be improved. As a result, the performance of multimodal-based document analysis can be significantly enhanced.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is an exemplary diagram for explaining a multimodal-based document analysis system according to some embodiments of the present disclosure;

FIG. 2 is a flowchart illustrating a multimodal-based document analysis method according to an embodiment of the present disclosure;

FIG. 3 is a diagram for explaining part of the method depicted in FIG. 2;

FIG. 4 is a diagram for explaining the overall operation of the multimodal-based document analysis method depicted in FIG. 2;

FIGS. 5 through 8 are diagrams illustrating part of the operation depicted in FIG. 4;

FIG. 9 is a flowchart illustrating a multimodal-based document analysis method according to another embodiment of the present disclosure;

FIG. 10 is a diagram for explaining part of the multimodal-based document analysis method depicted in FIG. 9; and

FIG. 11 is a diagram illustrating the hardware configuration of a computing device according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

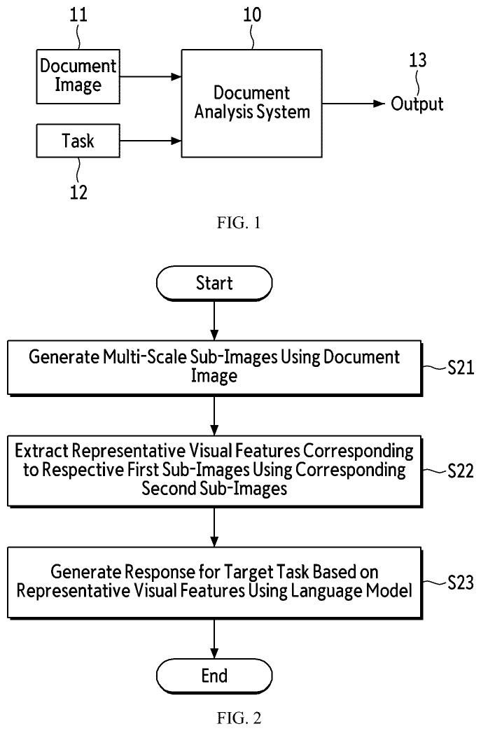

FIG. 1 is an exemplary diagram for explaining a multimodal-based document analysis system according to some embodiments of the present disclosure. In embodiments to be described below, “multimodal” may refer to an environment in which a plurality of data of different modalities are handled together. Here, the data of different modalities may refer to data that differ in type, form, characteristics (e.g., statistical characteristics), and/or domain. For example, text, image, and speech may be treated as data of different modalities. Also, for example, first data and second data having different statistical characteristics may be treated as data of different modalities. Furthermore, for example, first data (e.g., an image) and second data (e.g., an image) belonging to different domains may be treated as data of different modalities. That is, the term “multimodal” may encompass the concept of multi-domain.

Referring to FIG. 1, a document analysis system 10 may be a computing device/system having an analysis function for a document image 11. For example, the document analysis system 10 may generate a response 13 for a multimodal task 12 based on an input document image 11. Here, the document image 11 may refer to image data of a document in various formats. The multimodal task 12 may include image captioning, visual question answering, and image-text retrieval, but the present disclosure is not limited thereto, and any task that involves analyzing and extracting the configuration or information of the document image 11 may be included in the multimodal task 12.

Specifically, when the document image 11 to be analyzed and text indicating a specific multimodal task 12 are input together, the document analysis system 10 may generate a multi-scale sub-image set from the document image 11, extract a representative visual feature by integrating characteristic information extracted from the multi-scale sub-image set, and generate a response 13 for the multimodal task 12 based on the extracted representative visual feature using a multimodal large language model. A detailed description of this process will be provided later.

In addition, the document analysis system 10 may generate multi-scale sub-images (e.g., first sub-images and second sub-images) using a document image sample, and extract the representative visual features of the first sub-images by using second sub-images corresponding to each of the first sub-images via a visual feature integration model. Then, the document analysis system 10 may perform a target task based on the representative visual features using a language model and update the visual feature integration model and the language model, thereby significantly improving document analysis capability.

Meanwhile, the document analysis system 10 described above may be implemented by at least one computing device. For example, all functions of the document analysis system 10 may be implemented on a single computing device, or first and second functions of the document analysis system 10 may be implemented on first and second computing devices, respectively. Alternatively, a specific function of the document analysis system 10 may be implemented on multiple computing devices.

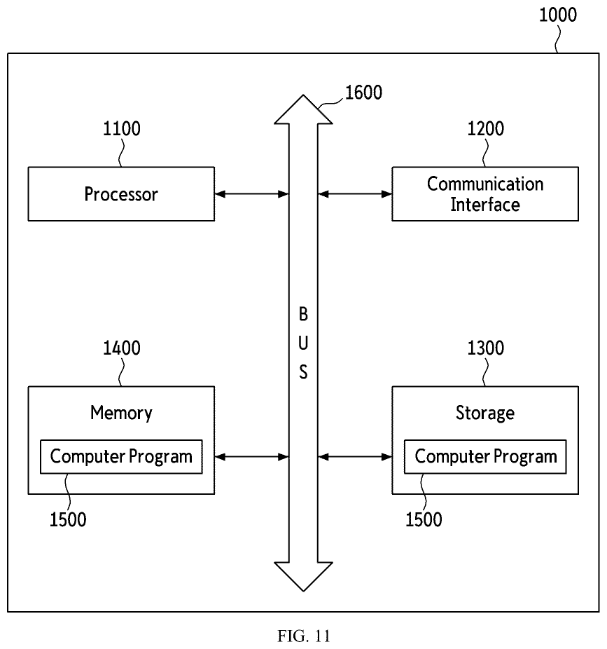

Here, the term “computing device” may include any device having a computing function, and an example of such a computing device is as illustrated in FIG. 11. Since a computing device is an aggregate in which various components (e.g., memory, processor, etc.) interact with each other, it may be referred to as a “computing system.” Also, a computing system may refer to an aggregate in which multiple computing devices interact with each other.

The document analysis system 10 has been briefly described so far with reference to FIG. 1. The aforementioned embodiments can be understood in further detail by referring to other embodiments to be described below. In addition, the technical ideas understood from the above embodiments may also be reflected in other embodiments to be described below, even if not explicitly stated.

Various methods that may be performed in the document analysis system 10 will now be explained with reference to FIG. 2 and subsequent drawings. For ease of understanding, the following description assumes that all steps/operations of the methods to be described below are performed in the document analysis system 10. Accordingly, when a subject for a specific step/operation is omitted, it may be understood to be the document analysis system 10. However, in practice, some steps/operations of the methods to be described below may be performed by other computing devices depending on the implementation.

FIG. 2 is a flowchart illustrating a multimodal-based document analysis method according to an embodiment of the present disclosure. However, this is merely an example for achieving the objectives of the present disclosure, and some steps/operations may obviously be added or omitted as needed.

Referring to FIG. 2, the multimodal-based document analysis method according to an embodiment of the present disclosure may begin with step S21 of generating multi-scale sub-images using a document image. Here, the multi-scale sub-images may include first sub-images of a first scale and second sub-images of a second scale different from the first scale.

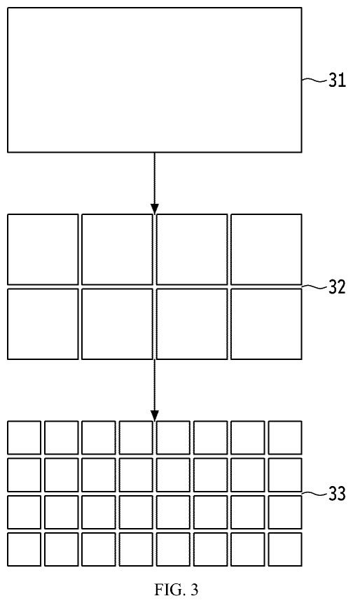

FIG. 3 is a diagram for explaining part of the method depicted in FIG. 2.

Referring to FIG. 3, when a target document image 31 is input, the document image 31 may be divided according to its aspect ratio, and first sub-images 32 of a first scale that has an aspect ratio corresponding to that of the document image 31 may be generated. At this time, a cropping method that considers the ratio of the document image 31 (e.g., shape-adaptive cropping (SAC)) may be applied. By determining the aspect ratio of the first sub-images 32 in consideration of the ratio of the document image 31, the entire area of the document image 31 may be included in the first sub-images 32, and information of the document image 31 may be preserved during the division of the document image 31. If the number of first sub-images becomes excessively large, computational cost may increase exponentially. To prevent this, a maximum number of first sub-images may be set in advance. For example, the maximum number of first sub-images may be set to generate up to nine first sub-images.

Thereafter, second sub-images 33 of a second scale may be generated by dividing each of the first sub-images 32. As illustrated, each of the first sub-images 32 may be divided into four parts, thereby generating second sub-images 33 corresponding to each of the first sub-images 32. For example, second sub-images 33 generated by dividing a specific first sub-image 32 may be understood to correspond to the specific first sub-image 32.

Thereafter, the generated first sub-images 32 and second sub-images 33 may be resized to a resolution corresponding to that of the document image 31. As a result, high-resolution multi-scale sub-images may be produced, allowing detailed areas of the document image 31 to be clearly identified.

Referring again to FIG. 2, in step S22, the representative visual features of the first sub-images may be extracted using the second sub-images corresponding to each of the first sub-images. Here, the representative visual features may refer to visual features that reflect key characteristics or information of the second sub-images corresponding to each of the first sub-images. A “visual feature” may also be referred to as a “visual token,” “image token,” “image feature,” “image feature map,” or simply a “feature map”.

Thereafter, in step S23, a response for a target task may be generated based on the representative visual features using a pre-trained language model. Here, the language model may be a multimodal large language model (MLLM), and may also be referred to as a large language model (LLM). The target task may refer to, for example, a task corresponding to a question text based on specific instructions input together with the document image, or the question text itself.

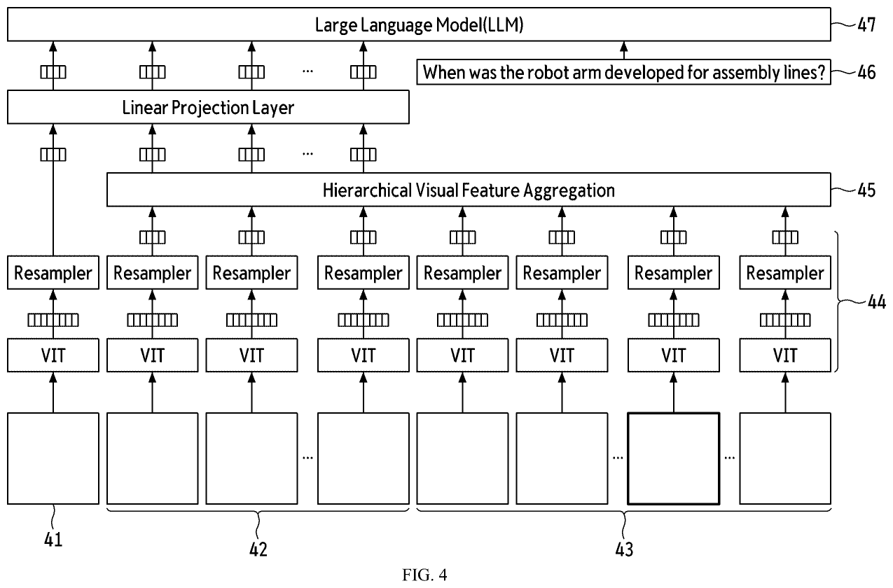

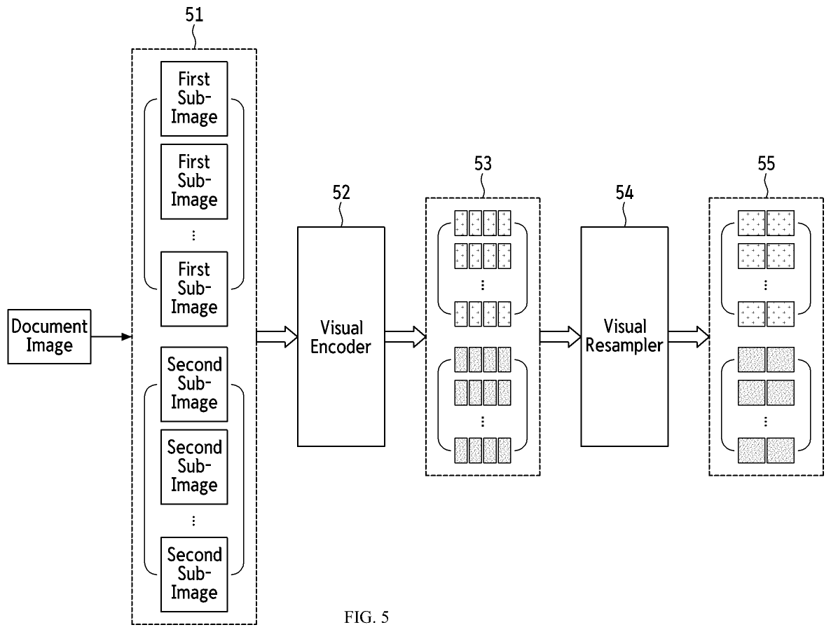

The operations described in FIG. 2 will hereinafter be described in further detail with reference to FIGS. 4 through 8.

FIG. 4 is a diagram for explaining the overall operation of the multimodal-based document analysis method depicted in FIG. 2.

Referring to FIG. 4, when a document image 41, first sub-images 42, and second sub-images 43 are input, visual features corresponding to the document image 41, first sub-images 42, and second sub-images 43 may be generated, as indicated by reference numeral 44. This will be described in detail with reference to FIG. 5.

FIG. 5 is a diagram for explaining part of the operation depicted in FIG. 4.

Referring to FIG. 5, when a document image is input, multi-scale sub-images 51, i.e., first sub-images and second sub-images, may be generated. For a detailed description of the generation of the multi-scale sub-images, reference is made to FIG. 3. Thereafter, when the document image and sub-images 51 are input into a visual encoder 52 (e.g., a visual transformer), visual tokens 53 corresponding to the document image and sub-images 51 may be generated. The visual tokens 53 generated by the visual encoder 52 may then be adjusted by a visual resampler 54 to a smaller number, resulting in visual tokens 55 in a reduced number. In this embodiment, the visual features of the document image, first sub-images, and second sub-images may all refer to the visual tokens ultimately generated through the visual encoder 52 and the visual resampler 54.

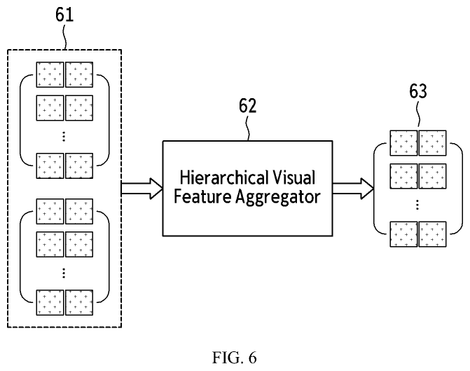

Referring again to FIG. 4, when the visual features of the first sub-images 42 and second sub-images 43 are input into a hierarchical visual feature aggregator 45, representative visual features of the first sub-images 42 may be extracted by using second sub-images 43 corresponding to each of the first sub-images 42. The hierarchical visual feature aggregator 45 may be referred to as a “visual feature integration model.” A detailed description of the hierarchical visual feature aggregator 45 will be provided later with reference to FIGS. 6 through 8.

Thereafter, the visual features of the document image 41 and the representative visual features of the first sub-images 42, extracted by the hierarchical visual feature aggregator 45, may be input into a language model 47. A response may then be generated for text 46 corresponding to a target task input together with the document image.

The process of extracting representative visual features will hereinafter be described in detail with reference to FIGS. 6 through 8.

FIGS. 6 through 8 are diagrams illustrating part of the operation depicted in FIG. 4.

Referring first to FIG. 6, when visual features 61 of first sub-images and second sub-images are input into a hierarchical visual feature aggregator 62, representative visual features 63 of the first sub-images may be extracted by using second sub-images corresponding to each of the first sub-images. Specifically, a compressed visual feature may be extracted by using the visual features of the second sub-images corresponding to each of the first sub-images, and a representative visual feature of the corresponding first sub-image may be generated by combining the visual feature of the corresponding first sub-image with the compressed visual feature. In this case, the compressed visual feature may have the same size as the visual feature of the corresponding first sub-image.

Specifically, a pooled visual feature may be extracted by applying max pooling to the visual features of the second sub-images corresponding to each of the first sub-images, and a compressed visual feature may be generated by applying cross attention between the pooled visual feature and the visual features of the second sub-images. In this process, the pooled visual feature may be used as a query (Q) input, and the visual features of the second sub-images may be used as key (K) and value (V) inputs.

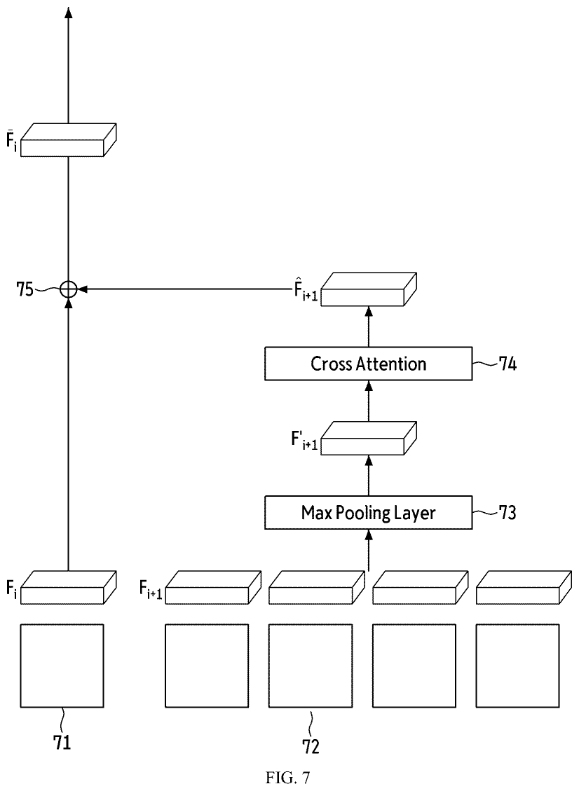

More specifically, referring to FIG. 7, max pooling (e.g., 2×2 max pooling) may be applied to visual features Fᵢ₊₁ of second sub-images 72 corresponding to a first sub-image 71 in a max pooling layer 73, thereby extracting a pooled visual feature F′ᵢ₊₁ having the same size as a visual feature Fᵢ of the first sub-image 71. In this case, Fᵢ₊₁ and F′ᵢ₊₁ may be expressed as follows:

$${F}_{i + 1} ∈ {ℝ}^{{H}_{i + 1} \times {W}_{i + 1} \times Q \times C} ; and {{F}^{′}}_{i + 1} ∈ {ℝ}^{{H}_{i} \times {W}_{i} \times Q \times C}$$

where Hᵢ×Wᵢ denotes the number of second sub-images 72, Q denotes the number of visual tokens for each of the second sub-images 72, and C denotes the number of channels.

Meanwhile, although notable and characteristic information of the visual features Fᵢ₊₁ of the second sub-images 72 may be reflected, other information may be lost. Accordingly, in this embodiment, a process of extracting features in a cross attention layer 74 is additionally included to minimize such information loss.

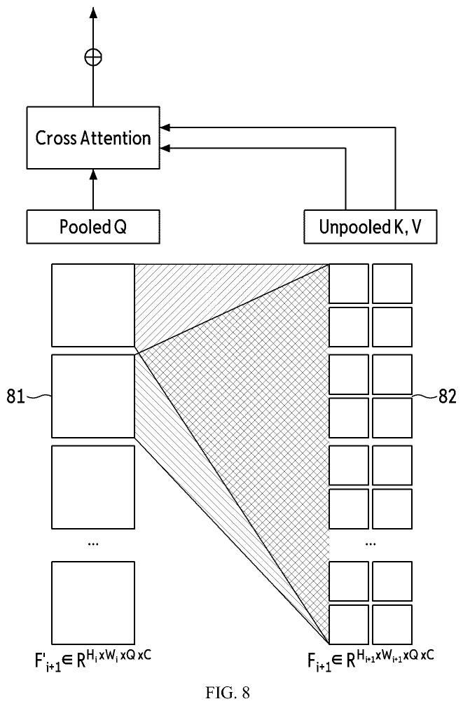

Specifically, referring to FIG. 8, a compressed visual feature \hat{F}ᵢ₊₁ may be generated by performing a cross attention operation according to Equation 1 below, in which a pooled visual feature 81 (i.e., F′ᵢ₊₁) is used as a query input, and visual features 82 (i.e., Fᵢ₊₁) of the second sub-images are used as key and value inputs.

$${\hat{F}}_{i + 1} = {{F}^{′}}_{i + 1} + soft max ( \frac{( {{F}^{′}}_{i + 1} {W}_{query} ) {( {F}_{i + 1} {W}_{key} )}^{T}}{\sqrt{d}} ) ( {F}_{i + 1} {W}_{value} ) {W}_{proj} \qquad [ Equation 1 ]$$

where W_{query}, W_{key}, Wᵥₐₗᵤₑ∈ [symbol] ^{C×d}, and Wₚᵣₒⱼ∈ [symbol] ^{d×C} represent learnable parameters, and d represents the dimensionality of the parameters.

Referring again to FIG. 7, a representative visual feature F̅ᵢ corresponding to the first sub-image 71 may be generated by fusing, as indicated by reference numeral 75, the compressed visual feature \hat{F}ᵢ₊₁ for the second sub-images 72 with the visual feature Fᵢ of the first sub-image 71, according to Equation 2 below.

$${\overline{F}}_{i} = {F}_{i} + {\hat{F}}_{i + 1} \qquad [ Equation 2 ]$$

Through this process, a representative visual feature may be generated in which the features of the second sub-images are combined with the first sub-image, while minimizing information loss. That is, the representative visual feature may include not only characteristic information of the first sub-image but also specific information of each of the second sub-images.

The multimodal-based document analysis method according to an embodiment of the present disclosure has been described so far with reference to FIGS. 2 through 8. According to the description in FIGS. 2 through 8, multi-scale sub-images may be generated using a document image, and representative visual features that incorporate characteristic information of all the sub-images may be extracted. As a result, while reducing the amount of visual features input into a language model, information loss may be minimized. Consequently, the computing cost and time required for processing a large amount of visual features may be significantly reduced, and the language model may better understand detailed content in the document image, particularly text written in various fonts, thereby greatly improving document analysis performance.

A training method for improving the performance of a multimodal-based document analysis system will hereinafter be described in detail.

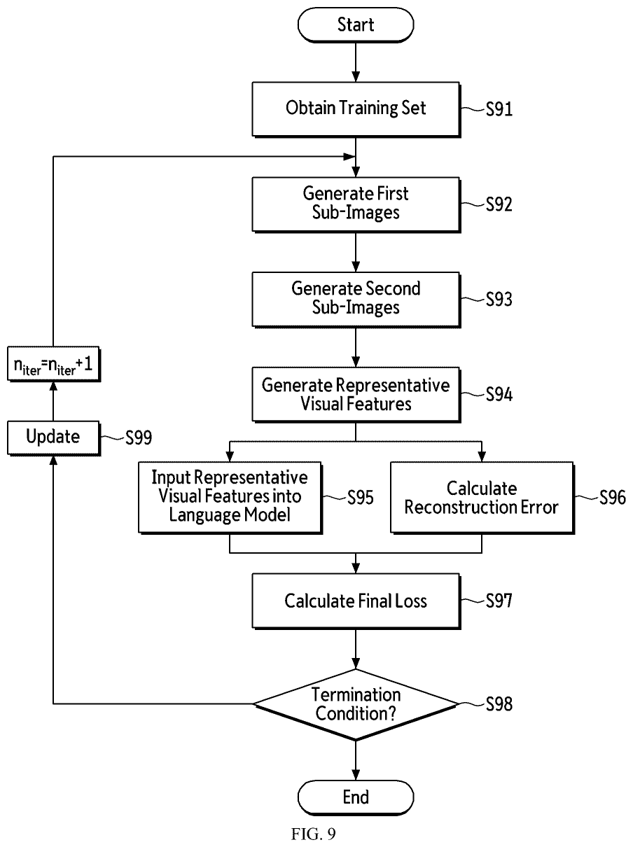

FIG. 9 is a flowchart illustrating a multimodal-based document analysis method according to another embodiment of the present disclosure. However, this is merely an example for achieving the objectives of the present disclosure, and some steps may be added or omitted as needed. Also, for the convenience of explanation, the acting subject of each step may be omitted, and any redundant explanations from the aforementioned embodiments may also be omitted.

The multimodal-based document analysis method according to this embodiment may begin with step S91 of obtaining a training set. The training set may include a plurality of document image samples. A “sample” or “data sample” refers to each piece of data that constitutes the training set, and may be used interchangeably with terms such as “example,” “instance,” “observation,” or “individual data”.

Thereafter, multi-scale sub-images may be generated using the document image samples. Specifically, in step S92, first sub-images of a first scale may be generated from the document image samples. In step S93, second sub-images corresponding to each of the first sub-images may be generated. Here, the second sub-images may be of a second scale different from the first scale. For detailed descriptions regarding the generation of the first sub-images and second sub-images, reference may be made to the description of the previous embodiment.

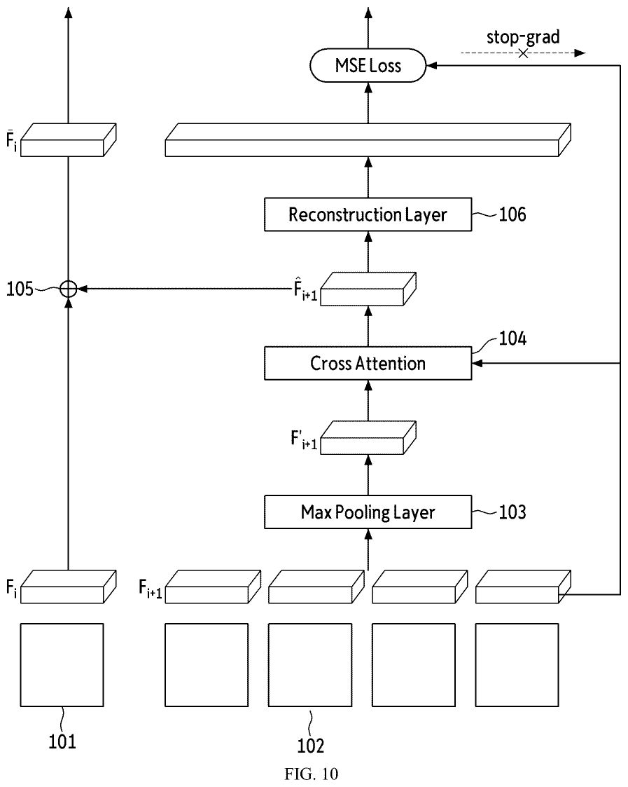

Thereafter, in step S94, representative visual features corresponding to the respective first sub-images may be extracted using the second sub-images corresponding to each of the first sub-images through a visual feature integration model. This will hereinafter be described with reference to FIG. 10.

FIG. 10 is a diagram for explaining part of the multimodal-based document analysis method depicted in FIG. 9.

Referring to FIG. 10, as in the previous embodiment, max pooling (e.g., 2×2 max pooling) may be applied to visual features Fᵢ₊₁ of second sub-images 102 corresponding to a first sub-image 101 in a max pooling layer 103, thereby extracting a pooled visual feature F′ᵢ₊₁ having the same size as a visual feature Fᵢ of the first sub-image 101 may be extracted. In addition, a compressed visual feature \hat{F}ᵢ₊₁ may be generated by performing a cross attention operation between the pooled visual feature F′ᵢ₊₁ and the visual features Fᵢ₊₁ of the second sub-images 102 in a cross attention layer 104. By fusing, as indicated by reference numeral 105, the compressed visual feature \hat{F}ᵢ₊₁ for the second sub-images 102 and the visual feature Fᵢ of the first sub-image 101, a representative visual feature F̅ᵢ corresponding to the first sub-image 101 may be generated.

Meanwhile, unlike its previous counterpart, the multimodal-based document analysis

method according to this embodiment may further include performing a decoding operation for reconstructing the generated compressed visual feature. Specifically, as illustrated in FIG. 10, a reconstructed visual feature may be generated by decoding the compressed visual feature \hat{F}ᵢ₊₁ through a decoder in a reconstruction layer 106, and visual feature compression loss [symbol] _{MSE} may be calculated according to Equation 3 below based on the similarity between the reconstructed visual feature and the visual features Fᵢ₊₁ of the second sub-images 102.

$${ℒ}_{MSE} ( {\hat{F}}_{i + 1} , {F}_{i + 1} ) = 𝔼 [ {( r ( {\hat{F}}_{i + 1} ) - stopgrad ( {F}_{i + 1} ) )}^{2} ] \qquad [ Equation 3 ]$$

Thereafter, the visual feature integration model may be updated based on the calculated visual feature compression loss. As a result, a compressed visual feature that includes more meaningful characteristics may be generated.

Referring again to FIG. 9, in step S95, the generated representative visual feature may be input into a language model, and the language model may perform a target task based on the representative visual feature. The target task may involve recognition or analysis of structural elements, textual elements, or image elements within each document image sample. In this case, if each document image sample exceeds the maximum input token length (or context window size) that the language model can process at once, information loss may occur, and the accuracy of task performance may be degraded. Accordingly, in this embodiment, the language model may be further trained using a task associated with relative position information of text in each document image sample, thereby improving its text recognition performance. For example, the language model may be trained with a task that instructs the language model to read the first 30% of the text content in each document image sample, or to predict the relative position in each document image sample where specific text is located. Specific examples of such a task involving the relative position information of text in each document image sample are provided in Table 1 below.

TABLE 1

| Task | Instruction Templates |
|---|---|
| RPT (first) | Human: What's in the first 30% of the image text? AI: {corresponding texts}. |
| | Human: Identify words from the first 15% of the image text. AI: {corresponding texts}. |
| RPT (middle) | Human: What are the words located between 10% and 55% of the text in the image? AI: |
| | {corresponding texts}. |
| | Human: List words found between 20% and 40% in the image text. AI: {corresponding texts}. |
| RPT (last) | Human: Identify words from the last 16% of the image text. AI: {corresponding texts}. |
| | Human: Which words make up the last 40% of the text in the image? AI: {corresponding texts}. |
| PTP | Human: Specify the relative position within the image where {query texts} is found. AI: 15%-30%. |
| | Human: Where is the text {query texts} located within the image? AI: 40%-80%. |

By additionally training the language model using the task associated with relative position information of text in each document image sample as described above, the performance of text recognition within each document image sample may be improved. As a result, the accuracy of task performance by the language model may be significantly enhanced.

Thereafter, in step S97, final loss [symbol] _{Final} may be calculated according to Equation 4 below based on the response result for the target task and the visual feature compression loss [symbol] _{MSE} calculated in step S96.

$${ℒ}_{Final} = {ℒ}_{MLLM} + {λℒ}_{MSE} \qquad [ Equation 4 ]$$

Thereafter, in step S99, the visual feature integration model and the language model may both be updated based on the final loss [symbol] _{Final}.

An exemplary computing device 1000 capable of implementing the above-described document analysis system 10 will hereinafter be described with reference to FIG. 11.

FIG. 11 is a hardware configuration diagram of a computing device according to some embodiments of the present disclosure.

Referring to FIG. 11, the computing device 1000 may include at least one processor 1100, a bus 1600, a communication interface 1200, a memory 1400 that loads a computer program 1500 executed by the processor 1100, and a storage 1300 that stores the computer program 1500. FIG. 11 illustrates only the components relevant to the embodiments of the present disclosure. Thus, although not illustrated, other general-purpose components may also be included in the computing device 1000. That is, the computing device 1000 may further include various components in addition to those depicted in FIG. 11. Also, in some embodiments, the computing device 1000 may be configured without some of the components illustrated in FIG. 11. Each component of the computing device 1000 will hereinafter be described.

The processor 1100 may control the overall operation of each component of the computing device 1000. The processor 1100 may include at least one processor such as a central processing unit (CPU), microprocessor unit (MPU), microcontroller unit (MCU), or graphics processing unit (GPU), all of which are well-known in the technical field of the present disclosure. Additionally, the processor 1100 may perform operations for at least one application or program for executing operations/methods according to embodiments of the present disclosure. The computing device 1000 may include one or more processors.

The memory 1400 may store various data, instructions, and/or information. The memory 1400 may load the computer program 1500 from the storage 1300 to execute the operations/methods according to embodiments of the present disclosure. The memory 1400 may be implemented as volatile memory such as random-access memory (RAM), but the present disclosure is not limited thereto.

The bus 1600 may provide a communication function between the components of the computing device 1000. The bus 1600 may be implemented as various types of buses, such as an address bus, data bus, or control bus.

The communication interface 1200 may support wired or wireless Internet communication for the computing device 1000. In addition, the communication interface 1200 may support various types of communication methods beyond internet communication. For this, the communication interface 1200 may include a communication module well known in the technical field of the present disclosure.

The storage 1300 may store one or more computer programs 1500 in a non-transitory manner. The storage 1300 may include a non-volatile memory such as a read-only memory (ROM), erasable programmable ROM (EPROM), electrically erasable programmable ROM (EEPROM), flash memory, a hard disk, a removable disk, or a computer-readable recording medium well known in the technical field of the present disclosure.

The computer program 1500 may include one or more instructions which, when loaded into the memory 1400, cause the processor 1100 to perform various operations/methods according to embodiments of the present disclosure. That is, by executing the loaded instructions, the processor 1100 may perform the operations/methods according to the various embodiments of the present disclosure.

In one example, the computer program 1500 may include instructions for: generating multi-scale sub-images using a document image, the multi-scale sub-images including first sub-images of a first scale and second sub-images of a second scale different from the first scale; extracting representative visual features corresponding to the respective first sub-images by using second sub-images corresponding to each of the first sub-images; and generating a response for a target task using a language model based on the representative visual features.

In another example, the computer program 1500 may include instructions for: generating multi-scale sub-images using document image samples, wherein the multi-scale sub-images include first sub-images of a first scale and second sub-images of a second scale different from the first scale; extracting representative visual features corresponding to the respective first sub-images using second sub-images corresponding to each of the first sub-images through a visual feature integration model; and updating the visual feature integration model and a language model by performing a target task based on the representative visual features using the language model.

In another example, the computer program 1500 may include instructions for performing at least some of the steps/operations/methods described with reference to FIGS. 1 through 10.

Meanwhile, in some embodiments, the computing device 1000 illustrated in FIG. 11 may refer to a virtual machine implemented based on cloud technology. For example, the computing device 1000 may be a virtual machine operating on one or more physical servers included in a server farm. In this case, at least some of the processor 1100, memory 1400, and storage 1300 depicted in FIG. 11 may correspond to virtual hardware components, and the communication interface 1200 may also be implemented as a virtualized networking component such as a virtual switch.

Various embodiments of the present disclosure and effects according to the embodiments have been mentioned with reference to FIGS. 1 to 11. The effects according to the technical spirits of the present disclosure are not limited to the above-mentioned effects, and other effects not mentioned will be clearly understood by those skilled in the art from the following description.

Furthermore, although a plurality of components have been described as being combined into one or operated in combination in the above embodiments, the technical spirits of the present disclosure are not necessarily limited thereto. That is, all of the components may operate to be selectively combined in one or more within the purpose scope of the technical spirits of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A multimodal-based document analysis method, performed by at least one computing device, comprising:
generating multi-scale sub-images using a document image, the multi-scale sub-images including first sub-images of a first scale and second sub-images of a second scale different from the first scale;
extracting representative visual features corresponding to the respective first sub-images by using second sub-images corresponding to each of the first sub-images; and
generating a response for a target task based on the representative visual features using a language model.

2. The multimodal-based document analysis method of claim 1, wherein the generating of the multi-scale sub-images comprises: generating the first sub-images of the first scale having an aspect ratio corresponding to that of the document image by dividing the document image; and resizing the first sub-images to a resolution corresponding to the document image.

3. The multimodal-based document analysis method of claim 1, wherein the generating of the multi-scale sub-images comprises: generating the second sub-images of the second scale by dividing a corresponding first sub-image; and resizing the second sub-images to a resolution corresponding to the document image.

4. The multimodal-based document analysis method of claim 1, wherein the generating of the representative visual features comprises: extracting compressed visual features by using visual features of the second sub-images corresponding to each of the first sub-images, the compressed visual features having a size corresponding to that of the visual features of the first sub-images; and generating the representative visual features corresponding to the respective first sub-images by fusing the visual features of the first sub-images with the corresponding compressed visual features.

5. The multimodal-based document analysis method of claim 4, wherein the extracting of the compressed visual features comprises: extracting pooled visual features by applying max pooling to the visual features of the second sub-images corresponding to each of the first sub-images; and generating the compressed visual features by applying cross attention between the pooled visual features and the visual features of the second sub-images.

6. The multimodal-based document analysis method of claim 5, wherein the generating of the compressed visual features comprises performing a cross attention operation in which the pooled visual features are used as query inputs and the visual features of the second sub-images are used as key and value inputs.

7. A multimodal-based document analysis method, performed by at least one computing device, comprising:
generating multi-scale sub-images using a document image sample, the multi-scale sub-images including first sub-images of a first scale and second sub-images of a second scale different from the first scale;
extracting representative visual features corresponding to the respective first sub-images by using second sub-images corresponding to each of the first sub-images through a visual feature integration model; and
updating the visual feature integration model and a language model by performing a target task based on the representative visual features using the language model.

8. The multimodal-based document analysis method of claim 7, wherein the generating of the multi-scale sub-images comprises: generating the first sub-images of the first scale having an aspect ratio corresponding to that of the document image sample by dividing the document image sample; and resizing the first sub-images to a resolution corresponding to the document image sample.

9. The multimodal-based document analysis method of claim 7, wherein the generating of the multi-scale sub-images comprises: generating the second sub-images of the second scale by dividing a corresponding first sub-image; and resizing the second sub-images to a resolution corresponding to the document image sample.

10. The multimodal-based document analysis method of claim 7, wherein the generating of the representative visual features comprises: extracting compressed visual features by using visual features of second sub-images corresponding to each of the first sub-images, the compressed visual features having a size corresponding to that of the visual features of the first sub-images; and generating the representative visual features corresponding to the respective first sub-images by fusing the visual features of the first sub-images with the corresponding compressed visual features.

11. The multimodal-based document analysis method of claim 10, wherein the extracting of the compressed visual features comprises: extracting pooled visual features by applying max pooling to the visual features of the second sub-images corresponding to each of the first sub-images; and generating the compressed visual features by applying cross attention between the pooled visual features and the visual features of the second sub-images.

12. The multimodal-based document analysis method of claim 10, wherein the updating of the visual feature integration model and the language model comprises: generating reconstructed visual features by reconstructing the compressed visual features; calculating visual feature compression loss based on similarity between the reconstructed visual features and the visual features of the second sub-images; and updating the visual feature integration model based on the visual feature compression loss.

13. The multimodal-based document analysis method of claim 7, wherein the target task includes a task associated with relative position information of text in the document image sample.

14. A multimodal-based document analysis system, comprising:
at least one processor; and
a memory storing a computer program executed by the at least one processor,
wherein the computer program includes instructions for: generating multi-scale sub-images using a document image, the multi-scale sub-images including first sub-images of a first scale and second sub-images of a second scale different from the first scale; extracting representative visual features corresponding to the respective first sub-images by using second sub-images corresponding to each of the first sub-images; and generating a response for a target task based on the representative visual features using a language model.

15. The multimodal-based document analysis system of claim 14, wherein the generating of the multi-scale sub-images comprises: generating the first sub-images of the first scale having an aspect ratio corresponding to that of the document image by dividing the document image; and resizing the first sub-images to a resolution corresponding to the document image.

16. The multimodal-based document analysis system of claim 14, wherein the generating of the multi-scale sub-images comprises: generating the second sub-images of the second scale by dividing a corresponding first sub-image; and resizing the second sub-images to a resolution corresponding to the document image.

17. The multimodal-based document analysis system of claim 14, wherein the generating of the representative visual features comprises: extracting compressed visual features by using visual features of second sub-images corresponding to each of the first sub-images, the compressed visual features having a size corresponding to that of the visual features of the first sub-images; and generating the representative visual features corresponding to the respective first sub-images by fusing the visual features of the first sub-images with the corresponding compressed visual features.

18. The multimodal-based document analysis system of claim 17, wherein the extracting of the compressed visual features comprises: extracting pooled visual features by applying max pooling to visual features of the second sub-images corresponding to each of the first sub-images; and generating the compressed visual features by applying cross attention between the pooled visual features and the visual features of the second sub-images.

19. The multimodal-based document analysis system of claim 18, wherein the generating of the compressed visual features comprises performing a cross attention operation in which the pooled visual features are used as query inputs, and the visual features of the second sub-images are used as key and value inputs.
